(19) United States
(12) Patent Application Publication
(10) Pub. No.: US 2024/0292440 A1
(43) Pub. Date: Aug. 29, 2024

(54) SIDELINK RESOURCE SELECTION PROCESSING METHOD AND APPARATUS, TERMINAL, AND READABLE STORAGE MEDIUM

(71) Applicant: VIVO MOBILE COMMUNICATION CO., LTD., Dongguan (CN)

(72) Inventors: Huan WANG, Dongguan (CN); Zichao JI, Dongguan (CN)

(73) Assignee: VIVO MOBILE COMMUNICATION CO., LTD., Dongguan (CN)

(21) Appl. No.: 18/655,312

(22) Filed: May 5, 2024

Related U.S. Application Data
(63) Continuation of application No. PCT/CN2022/129469, filed on Nov. 3, 2022.

(30) Foreign Application Priority Data
Nov. 5, 2021 (CN) 202111306911.3

(51) Int. Cl. H04W 72/40

(52) U.S. Cl. CPC H04W 72/40

(57) ABSTRACT

This application discloses a sidelink resource selection processing method and apparatus, a terminal, and a readable storage medium. The sidelink resource selection processing method includes: a first terminal determines a non-preferred resource set; and the first terminal performs a resource exclusion behavior based on a first preset rule and the non-preferred resource set.

### CROSS-REFERENCE TO RELATED APPLICATIONS

This application is a continuation of International Application No. PCT/CN2022/129469, filed Nov. 3, 2022, which claims priority to Chinese Patent Application No. 202111306911.3, filed Nov. 5, 2021. The entire contents of each of the above-referenced applications are expressly incorporated herein by reference.

### TECHNICAL FIELD

This application pertains to the field of communication technologies, and in particular, to a sidelink resource selection processing method and apparatus, a terminal, and a readable storage medium.

### BACKGROUND

With development of communication technologies, Sidelink (SL) transmission is widely used. Currently, a sidelink resource may be autonomously selected by a terminal, or may be allocated by a network side device. In an autonomous selection manner, generally, after resource selection is triggered, a transmit user equipment (TX UE) first determines a resource selection window, determines a candidate resource set based on the resource selection window, and then performs resource exclusion on candidate resources to obtain a target candidate resource set. Currently, the resource exclusion is performed based only on Reference Signal Received Power (RSRP) and a non-monitored slot that are measured on resources in the resource selection window, to obtain a final target candidate resource set. In this way, when sidelink resources used for transmission are randomly selected from the target candidate resource set, selected sidelink resources are prone to being unable to be transmitted (for example, there is a conflict with other resources). Consequently, there is a problem of low reliability of SL transmission in a conventional technology.

### SUMMARY

Embodiments of this application provide a sidelink resource selection processing method and apparatus, a terminal, and a readable storage medium, which can improve reliability of SL transmission.

According to a first aspect, a sidelink resource selection processing method is provided, including:

A first terminal determines a non-preferred resource set.

The first terminal performs a resource exclusion behavior based on a first preset rule and the non-preferred resource set.

According to a second aspect, a sidelink resource selection processing apparatus is provided, including:

a determining module, configured to determine a non-preferred resource set; and

a processing module, configured to perform a resource exclusion behavior based on a first preset rule and the non-preferred resource set.

According to a third aspect, a terminal is provided. The terminal includes a processor, a memory, and a program or an instruction that is stored in the memory and that can be run on the processor. When the program or the instruction is executed by the processor, the steps in the method according to the first aspect are implemented.

According to a fourth aspect, a terminal is provided, including a processor and a communication interface.

The processor is configured to determine a non-preferred resource set.

The communication interface is configured to perform a resource exclusion behavior based on a first preset rule and the non-preferred resource set.

According to a fifth aspect, a readable storage medium is provided. The readable storage medium stores a program or an instruction. When the program or the instruction is executed by a processor, the steps in the method according to the first aspect are implemented.

According to a sixth aspect, an embodiment of this application provides a chip. The chip includes a processor and a communication interface. The communication interface is coupled to the processor, and the processor is configured to run a program or an instruction, to implement the steps in the method according to the first aspect.

According to a seventh aspect, a computer program/program product is provided. The computer program/program product is stored in a non-transient storage medium. The computer program/program product is executed by at least one processor to implement the method according to the first aspect.

In the embodiments of this application, the first terminal determines the non-preferred resource set; and the first terminal performs the resource exclusion behavior based on the first preset rule and the non-preferred resource set. In this way, the first terminal may perform the resource exclusion based on the non-preferred resource, thereby improving reliability of sidelink transmission.

### BRIEF DESCRIPTION OF DRAWINGS

FIG. 1 is a diagram of a structure of a network system to which embodiments of this application can be applied;

FIG. 2 is a flowchart of a sidelink resource selection processing method according to an embodiment of this application;

FIG. 3 is a diagram of a structure of a sidelink resource selection processing apparatus according to an embodiment of this application;

FIG. 4 is a diagram of a structure of a communication device according to an embodiment of this application; and

FIG. 5 is a diagram of a structure of a terminal according to an embodiment of this application.

### DETAILED DESCRIPTION

The following clearly describes technical solutions in embodiments of this application with reference to accompanying drawings in the embodiments of this application. It is clear that the described embodiments are a portion of but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the description and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-advanced (LTE-A) system, and can also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe a New Radio (NR) system for example purposes, and NR terms are used in most of the following descriptions, but these technologies can also be applied to an application other than an NR system application, for example, a 6th Generation (6G) communication system.

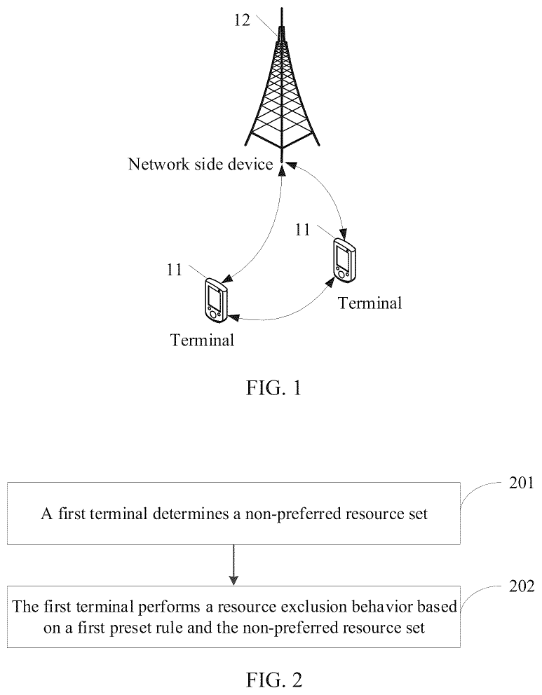

FIG. 1 is a block diagram of a wireless communication system to which embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture). The wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, a game console, and the like. It should be noted that a specific type of the terminal 11 is not limited in the embodiments of this application. The network side device 12 may be a base station or a core network device. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmitting Receiving Point (TRP), or another suitable term in the field provided that a same technical effect is achieved. The base station is not limited to a specific technical term. It should be noted that, in the embodiments of this application, only a base station in an NR system is used as an example, but a specific type of the base station is not limited.

For ease of understanding, the following describes a portion of content in the embodiments of this application.

### 1. NR SL Resource Allocation or Selection

There are two NR SL resource allocation modes, one is a resource allocation mode based on base station scheduling (mode 1), and the other is a resource allocation mode based on autonomous resource selection of UE (mode 2). With regard to the resource allocation mode based on base station scheduling, a sidelink resource used by the UE for data transmission is determined by the base station, and TX UE is notified by using downlink signaling. With regard to the resource allocation mode based on autonomous resource selection of UE, the UE selects an available transmission resource from a configured or pre-configured resource pool. Before resource selection, the UE performs channel sensing, selects a resource set with less interference based on a channel sensing result, and then randomly selects a resource for transmission from the resource set.

A specific working manner for the mode 2 includes the following steps.

Step 1: After the resource selection is triggered, the TX UE first determines a resource selection window, where a lower boundary of the resource selection window is at a T1 time after the resource selection is triggered, and an upper boundary of the resource selection is at a T2 time after the trigger, where T2 is a value selected in a manner implemented by the UE in a packet delay budget (PDB) transmitted by a transport block (TB) of the UE, and T2 is not earlier than T1.

Step 2: Before the resource selection, the UE needs to determine a candidate resource set for the resource selection, and compare an RSRP measured on a resource in the resource selection window with a corresponding RSRP threshold; and when the RSRP is greater than the RSRP threshold, the resource is excluded and cannot be included in the candidate resource set. After resource exclusion, remaining resources in the resource selection window form a target candidate resource set. Resources in the target candidate resource set account for no less than x % of resources in the resource selection window. When the resources in the target candidate resource set account for less than x % of the resources in the resource selection window, the RSRP threshold needs to be increased based on a step-by-step value (3 dB), and then the resource exclusion is performed until no less than x % of the resources can be selected. In some embodiments, all the resources included in the resource selection window may be referred to as an initial candidate resource set.

Step 3: After the target candidate resource set is determined, the UE randomly selects a transmission resource from the target candidate resource set. In addition, the UE may reserve a transmission resource for next transmission in this transmission.

Step 2 may include the following refinement procedure.

Step 2.1: The UE determines a candidate resource based on the resource selection window, where a total quantity of candidate resources is denoted as M_total.

Step 2.2: The UE obtains a sensing result in a sensing window, for example, reserved information in a PSCCH, and an RSRP measurement value associated with a reserved resource.

Step 2.3: The UE determines an initial RSRP threshold.

Step 2.4: The UE initializes the candidate resource set, including all candidate resources determined in step 2.1 (which may also be referred to as all candidate resources in the resource selection window or all candidate resources in the initial candidate resource set).

Step 2.5: The UE performs the resource exclusion based on a non-monitored slot, to exclude, from the candidate resource set, a resource satisfying a preset condition 1.

Step 2.5a: When a quantity of remaining resources in the candidate resource set is less than x %*M_total after the resource exclusion is performed based on step 2.5, restore the candidate resource set to the initial candidate resource set determined in step 2.4.

Step 2.6: The UE performs the resource exclusion based on a comparison between the RSRP measurement value and the RSRP threshold, to exclude, from the candidate resource set, a resource satisfying a preset condition 2.

Step 2.7: When the quantity of the remaining resources in the candidate resource set is less than x %*M_total and an RSRP threshold is increased by 3 dB after the resource exclusion is performed based on step 2.6, continue to return to step 2.4.

The following describes in detail a sidelink resource selection processing method provided in embodiments of this application by using some embodiments and application scenarios of the embodiments with reference to the accompanying drawings.

FIG. 2 is a flowchart of a sidelink resource selection processing method according to an embodiment of this application. As shown in FIG. 2, the method includes the following steps.

Step 201: A first terminal determines a non-preferred resource set.

In this embodiment of this application, the non-preferred resource set may include one or more non-preferred resources. The non-preferred resource may be understood as a resource not expected to be used, for example, may include at least one of a resource not expected to be used by the first terminal or a resource not expected to be used by a second terminal. The second terminal may send auxiliary information to the first terminal, and notify, by using the auxiliary information, the first terminal of a resource not expected to be used. In addition, the first terminal may receive resources not expected to be used sent by one or more second terminals.

Step 202: The first terminal performs a resource exclusion behavior based on a first preset rule and the non-preferred resource set.

The first preset rule may be understood as a rule for the first terminal to perform resource exclusion on the non-preferred resource set when the first terminal performs the resource exclusion behavior. The first preset rule may be agreed upon in a protocol, configured, or pre-configured.

It should be noted that in this embodiment of this application, the resource exclusion behavior may include performing the resource exclusion based on the non-preferred resource set, or may include the resource exclusion behavior in the foregoing conventional technology, for example, performing the resource exclusion based on a non-monitored slot and performing the resource exclusion based on an RSRP measurement value. Performing the resource exclusion based on the non-preferred resource set may occur during the resource exclusion behavior in the foregoing conventional technology, may occur before the resource exclusion behavior in the foregoing conventional technology, or may occur after the resource exclusion behavior in the foregoing conventional technology. A specific time at which the resource exclusion behavior is performed is not further limited herein. For example, in some embodiments, the resource exclusion may be performed based on the non-preferred resource set between step 2.6 and step 2.7, the resource exclusion may be performed based on the non-preferred resource set after step 2.7, or the resource exclusion may be performed based on the non-preferred resource set before or after another step, which is not listed one by one herein.

In this embodiment of this application, the first terminal determines the non-preferred resource set; and the first terminal performs the resource exclusion behavior based on the first preset rule and the non-preferred resource set. In this way, the first terminal may perform the resource exclusion based on the non-preferred resource, thereby improving reliability of sidelink transmission.

In some embodiments, the first preset rule includes any one of the following:
Rule 1: performing resource exclusion based on a first threshold for a non-preferred resource that can be used for resource exclusion by the first terminal, where the first threshold is a quantity threshold or a ratio threshold;
Rule 2: performing exclusion on at least a portion of non-preferred resources in the non-preferred resource set based on a second threshold;
Rule 3: when resource exclusion is performed based on the non-preferred resource set, determining a resource quantity requirement of a target candidate resource set based on a third threshold;
Rule 4: when resource exclusion is performed based on the non-preferred resource set, an upper limit value of a reference signal received power RSRP threshold is a preset value;
Rule 5: when a quantity of non-preferred resources used for resource exclusion is greater than a first preset value, performing a preset resource exclusion behavior;
Rule 6: when a sum of a quantity of non-preferred resources used for resource exclusion and a quantity of first resources is greater than a first preset value, performing a preset resource exclusion behavior, where the first resource is a resource that is excluded based on a non-monitored slot;
Rule 7: performing resource exclusion on an intermediate candidate resource set based on the non-preferred resource set, where the intermediate candidate resource set is a candidate resource set obtained before the resource exclusion is performed based on the non-preferred resource set, and a threshold for a resource quantity requirement of the intermediate candidate resource set is greater than a fourth threshold;
Rule 8: when resource exclusion is performed based on the non-preferred resource set, triggering resource reselection when a quantity of remaining resources in a candidate resource set is less than or equal to a fourth threshold;
Rule 9: when resource exclusion is performed by a MAC layer based on the non-preferred resource set, reporting, by a physical layer, an intermediate candidate resource set and the non-preferred resource set to the MAC layer, where the intermediate candidate resource set is a candidate resource set obtained before the resource exclusion is performed based on the non-preferred resource set; or
Rule 10: when resource exclusion is performed based on the non-preferred resource set, a resource selection window satisfies at least one of the following: a latest start time of the resource selection window is later than a first time; or minimum duration of the resource selection window is less than first duration, where the first time is a latest start time of a resource selection window used when the resource exclusion is not performed based on the non-preferred resource set, and the first duration is minimum duration of a resource selection window used when the resource exclusion is not performed based on the non-preferred resource set.

In some embodiments, the fourth threshold is a threshold used to determine the resource quantity requirement of the target candidate resource set when the resource exclusion is not performed based on the non-preferred resource set.

In this embodiment of this application, the fourth threshold may be understood as a ratio of a quantity of resources in the target candidate resource set to a quantity of resources in an initial candidate resource set, for example, the foregoing x %. The target candidate resource set may be understood as a final candidate resource set obtained after the resource exclusion is performed, and the first terminal may randomly select a transmission resource from the target candidate resource set.

It should be understood that when the resource exclusion is performed based on the first threshold for the non-preferred resource that can be used for the resource exclusion by the first terminal, the first threshold may be agreed upon in a protocol, pre-configured, or configured. A quantity of non-preferred resources that can be used for the resource exclusion may be limited by the first threshold, so that the quantity of the non-preferred resources that can be used for the resource exclusion, a maximum quantity, a minimum quantity, or a range of the quantity may be limited.

With respect to Rule 1, in some embodiments, when the first preset rule includes the performing resource exclusion based on a first threshold for a non-preferred resource that can be used for resource exclusion by the first terminal, the first preset rule satisfies at least one of the following:

Rule 1.1: A first quantity of non-preferred resources that can be used for the resource exclusion or a ratio of the first quantity to an initial candidate resource set is less than or equal to the first threshold.

Rule 1.2: When a first quantity of resources in the non-preferred resource set is greater than the first threshold, a terminal selects a portion of non-preferred resources for the resource exclusion, where a quantity of the portion of the non-preferred resources is less than or equal to the first threshold.

Rule 1.3: When a first quantity of resources in the non-preferred resource set is less than or equal to the first threshold, a terminal determines that all the resources in the non-preferred resource set are used for the resource exclusion.

Rule 1.4: In a process of performing the resource exclusion based on the non-preferred resource set, when the quantity of the remaining resources in the candidate resource set is less than the fourth threshold, a first quantity of non-preferred resources that can be used for the resource exclusion or a ratio of the first quantity to an initial candidate resource set is less than or equal to the first threshold; or when the quantity of the remaining resources in the candidate resource set is greater than or equal to the fourth threshold, resources in the non-preferred resource set are sequentially excluded until a first preset condition is satisfied, where the first preset condition indicates that the resources in the non-preferred resource set are continued to be excluded, so that the quantity of the remaining resources in the candidate resource set is less than the fourth threshold.

In this embodiment of this application, that the first quantity of non-preferred resources that can be used for the resource exclusion or a ratio of the first quantity to an initial candidate resource set is less than or equal to the first threshold may be understood as: The first quantity of non-preferred resources that can be used for the resource exclusion is less than or equal to the quantity threshold, and the ratio of the first quantity to the initial candidate resource set is less than or equal to the ratio threshold. In some embodiments, the ratio threshold may be understood as 1-x %, and the quantity threshold may be understood as (1-x %)M_total. In this way, it can be avoided that a dead cycle occurs due to the fact that an excessive quantity of non-preferred resources are excluded, and consequently, a quantity of resources in the candidate resource set does not satisfy the resource quantity requirement used to determine the target candidate resource set. That is, a dead cycle is avoided to occur in step 2.4 to step 2.7.

In some embodiments, with respect to Rule 1.2 and Rule 1.3, it may be understood that when the quantity of the non-preferred resources or the ratio detected by the first terminal is greater than the first threshold, the first terminal selects a portion of non-preferred resources for the resource exclusion, and a quantity of selected non-preferred resource satisfies a limit value requirement corresponding to the first threshold. When the quantity of the non-preferred resources or the ratio detected by the terminal is less than or equal to the first threshold, all the detected non-preferred resources are used for the resource exclusion.

In some embodiments, with respect to Rule 1.4, it may be understood that when the quantity of the remaining resources in the candidate resource set is less than the fourth threshold, the resource exclusion may be performed by using the first threshold. When the quantity of the remaining resources in the candidate resource set is greater than or equal to the fourth threshold (for example, x %*M_total), the terminal excludes as many non-preferred resources as possible, provided that the quantity of the remaining resources in the candidate resource set is greater than or equal to the fourth threshold.

With respect to Rule 2, it may be understood that a quantity or a proportion of candidate resources that are excluded based on the non-preferred resource is limited (the quantity of the candidate resources that are excluded based on the non-preferred resource is equivalent to a proportion of a quantity of resources in the initial candidate resource set), to implement enhanced resource selection. In some embodiments, when the first preset rule includes the performing exclusion on at least a portion of non-preferred resources in the non-preferred resource set based on a second threshold, the first preset rule satisfies at least one of the following:

Rule 2.1: After the resource exclusion is performed based on the non-preferred resource set, a quantity of reduced resources in the candidate resource set satisfies a second preset condition.

Rule 2.2: In a process of performing the resource exclusion based on the non-preferred resource set, when the quantity of the remaining resources in the candidate resource set is less than the fourth threshold, a quantity of reduced resources in the candidate resource set satisfies a second preset condition; or when the quantity of the remaining resources in the candidate resource set is greater than or equal to the fourth threshold, resources in the non-preferred resource set are sequentially excluded until a first preset condition is satisfied, where the first preset condition indicates that the resources in the non-preferred resource set are continued to be excluded, so that the quantity of the remaining resources in the candidate resource set is less than the fourth threshold.

In some embodiments, with respect to Rule 2.1, the second preset condition may include at least one of the following: The quantity of the reduced resources is less than or equal to a second preset value, where the second preset value is determined based on the second threshold.

A ratio of the quantity of the reduced resources to a quantity of resources in an initial candidate resource set is less than or equal to a first preset proportion, where the first preset proportion is determined based on the second threshold.

In this embodiment of this application, the second threshold may be a value, that is, a limited value indicating a quantity of candidate resources that are excluded based on the non-preferred resource, or may be a ratio, that is, a limited value indicating a ratio of a quantity of candidate resources that are excluded based on the non-preferred resource to the quantity of the resources in the initial candidate resource set. When the second preset value is the limited value of the quantity, that the second preset value is determined based on the second threshold may be understood as: The second preset value is the second threshold. That the first preset proportion is determined based on the second threshold may be understood as: The first preset proportion is a ratio of the second threshold to the quantity of the resources in the initial candidate resource set. When the second preset value is the ratio threshold, that the second preset value is determined based on the second threshold may be understood as: The second preset value is a product of the second threshold and the quantity of the resources in the initial candidate resource set. That the first preset proportion is determined based on the second threshold may be understood as: The first preset proportion is the second threshold. In this embodiment of this application, the terminal may exclude as many non-preferred resources as possible, provided that Rule 2.1 is satisfied.

In some embodiments, the second threshold may be agreed upon in a protocol, configured, or pre-configured, or may be obtained according to an agreed rule.

In some embodiments, with respect to Rule 2.2, it may be understood that when the quantity of the remaining resources in the candidate resource set is less than the fourth threshold, the resource exclusion may be performed by using the second preset condition. When the quantity of the remaining resources in the candidate resource set is greater than or equal to the fourth threshold (for example, x %*M_total), the terminal excludes as many non-preferred resources as possible, provided that the quantity of the remaining resources in the candidate resource set is greater than or equal to the fourth threshold.

In some embodiments, the third threshold is a minimum ratio of a quantity of resources in the target candidate resource set to a quantity of resources in an initial candidate resource set. The third threshold may be agreed upon in a protocol, configured, or pre-configured, or may be obtained according to an agreed rule. In this embodiment of this application, with respect to Rule 3, it may be understood that a proportion of candidate resources in the candidate resource set is reduced or controlled. For example, when the step of performing the resource exclusion based on the non-preferred resource set is between step 2.6 and step 2.7, x % in step 2.7 may be reduced.

In some embodiments, the third threshold is a third preset proportion that is agreed upon in a protocol, pre-configured, configured, or determined according to an agreed rule, or the third threshold is determined based on the fourth threshold and a first preset offset value.

For example, in some embodiments, when the first terminal performs the resource exclusion based on the non-preferred resource, UE determines, by using an additionally configured or pre-configured proportion y %, whether determining of the candidate resource set is completed, where y % represents the third threshold, and y % may be less than x %.

For example, in some embodiments, when the first terminal performs the resource exclusion based on the non-preferred resource, the first terminal assumes that the proportion x % has an offset (that is, the first preset offset value), and determines, based on a proportion (x %−offset), whether determining of the candidate resource set is completed. The proportion may be understood as a ratio of a quantity of resources in the target candidate resource set to a quantity of resources in the initial candidate resource set.

The first preset offset value is agreed upon in a protocol, pre-configured, configured, or determined according to an agreed rule. In some embodiments, the first preset offset value may be further determined based on the non-preferred resource. For example, the first preset offset value may be further a proportion of candidate resources in the non-preferred resources in the initial candidate resource set.

When the third threshold is the minimum ratio of the quantity of the resources in the target candidate resource set to the quantity of the resources in the initial candidate resource set, with respect to Rule 3, it may be understood that a quantity of candidate resources that are excluded based on the non-preferred resource is limited.

After a non-preferred resource is excluded, a proportion of the candidate resources in the candidate resource set is greater than y % (that is, the third threshold), where the proportion is a proportion of remaining candidate resources to the candidate resources in the initial candidate resource set. The first terminal may exclude as many non-preferred resources as possible, provided that the condition in this embodiment is satisfied.

In some embodiments, the third threshold is a ratio of a quantity of resources in the target candidate resource set to a second quantity, and the second quantity is a difference between a quantity of resources in an initial candidate resource set and a second preset offset value, or the second quantity is a product of a quantity of resources in an initial candidate resource set and a third preset proportion.

In this embodiment of this application, Rule 3 may be understood that a base of the proportion of the candidate resources in the candidate resource set is reduced or controlled. For example, when the step of performing the resource exclusion based on the non-preferred resource set is between step 2.6 and step 2.7, M_total in step 2.7 may be reduced.

For example, in some embodiments, when the first terminal performs the resource exclusion based on the non-preferred resource, the first terminal assumes that a base of the proportion is M_total−offset or M_total*y %, and determines, based on M_total−offset or M_total*y %, whether determining of the candidate resource set is completed. In this embodiment, the offset may be understood as the second preset offset value, and y % may be understood as the third preset proportion.

With respect to Rule 4, it may be understood that when the first terminal performs the resource exclusion based on the non-preferred resource, an upper limit value of an RSRP threshold used for the resource exclusion is the preset value, and the preset value is agreed upon in a protocol, pre-configured, or configured. Because the upper limit value of the RSRP threshold is limited, it can be avoided that a dead cycle occurs due to the fact that an excessive quantity of non-preferred resources are excluded, and consequently, a quantity of resources in the target candidate resource set does not satisfy the resource quantity requirement used to determine the target candidate resource set. For example, in step 2.7, when it is assumed that the RSRP threshold is again increased by 3 dB, and that the RSRP threshold is greater than or equal to the preset value, the resource exclusion behavior may no longer be performed, and a candidate resource set determined before the resource exclusion is performed based on the RSRP is determined as the target candidate resource set.

In some embodiments, the preset resource exclusion behavior includes any one of the following:
skipping performing the resource exclusion based on the non-preferred resource set;
after performing the resource exclusion based on the non-preferred resource set, retrieving at least a portion of resources from non-preferred resources that have been excluded;
when the sum of the quantity of the non-preferred resources used for the resource exclusion and the quantity of the first resources is greater than the first preset value, restoring at least a portion of the first resources; or
when the sum of the quantity of the non-preferred resources used for the resource exclusion and the quantity of the first resources is greater than the first preset value, skipping performing the resource exclusion based on the non-preferred resource set and restoring at least a portion of the first resources.

In this embodiment of this application, with respect to Rule 5, when the quantity of the non-preferred resources is greater than the first preset value (for example, (1-x %)*M_total), the first terminal does not exclude the non-preferred resource, or after the resource exclusion is performed based on the non-preferred resource set, retrieves at least a portion of resources from the non-preferred resources that have been excluded. Therefore, a dead cycle may be avoided to occur in step 2.4 to step 2.7.

In this embodiment of this application, with respect to Rule 6, when a sum of the quantity of the non-preferred resources and a quantity of resources that are excluded based on the non-monitored slot is greater than the preset value (for example, (1-x %)*M_total), the first terminal performs at least one of the following:

skipping excluding the non-preferred resource, or after the resource exclusion is performed based on the non-preferred resource set, retrieving at least a portion of resources from the non-preferred resources that have been excluded; or

restoring at least a portion of resources that are excluded based on the non-monitored slot.

In this way, it can be avoided that a dead cycle occurs due to the fact that an excessive quantity of resources are excluded, and consequently, a quantity of resources in the target candidate resource set does not satisfy the resource quantity requirement used to determine the target candidate resource set. That is, a dead cycle may be avoided to occur in step 2.4 to step 2.7.

In some embodiments, with respect to Rule 7, it may be understood that a quantity of remaining candidate resources in the candidate resource set is expanded, and then the resource exclusion is performed based on the non-preferred resource. For example, x % in step 2.7 is increased, and it is assumed that the increased x % is denoted as y %. When the first terminal performs the resource exclusion based on the non-preferred resource, x % in step 2.7 is replaced with y %. When the first terminal performs existing resource exclusion (the resource exclusion is not performed based on the non-preferred resource set), x % in step 2.7 is unchanged.

It should be noted that, in this embodiment of this application, when the first terminal performs the resource exclusion based on the non-preferred resource, after a non-preferred resource is excluded, a proportion of candidate resources in the candidate resource set is greater than or equal to x %, where the proportion is a proportion of remaining candidate resources to candidate resources in an initial candidate resource set. The first terminal may exclude as many non-preferred resources as possible, provided that the proportion of the candidate resources in the candidate resource set is greater than or equal to x %.

It should be understood that the intermediate candidate resource set may be understood as the target candidate resource set determined by using step 2.4 to step 2.7 in a conventional technology.

In some embodiments, with respect to Rule 8, it may be understood that when the first terminal performs the resource exclusion based on the non-preferred resource, and a quantity of reported resources is less than x %*M_total, the first terminal triggers resource reselection or the first terminal readjusts a resource selection window to perform resource reselection.

In some embodiments, with respect to Rule 10, it may be understood that when the first terminal performs the resource exclusion based on the non-preferred resource, a limit on a start time T1 and/or an end time T2 of the resource selection window is relaxed, so that UE more flexibly adjusts the resource selection window, to control a quantity of non-preferred resources in the window.

For example, maximum duration from a start location of resource selection to T1 is greater than a preset value (the preset value is greater than a preset value in a conventional technology), or maximum duration from a start location of resource selection to T1 is not limited.

For example, a duration interval between T1 and T2 is less than a second preset value (the preset value is less than a preset value in a conventional technology).

In some embodiments, the first preset rule includes:

when a quantity of remaining resources in a candidate resource set is greater than or equal to a fourth threshold, sequentially excluding resources in the non-preferred resource set until a first preset condition is satisfied, where the first preset condition indicates that the resources in the non-preferred resource set are continued to be excluded, so that the quantity of the remaining resources in the candidate resource set is less than the fourth threshold.

In some embodiments, that a first terminal determines a non-preferred resource set includes:

The first terminal receives non-preferred resources from N second terminals, where N is a positive integer.

When a quantity of received non-preferred resources is greater than a quantity of non-preferred resources that can be used for resource exclusion by the first terminal, the first terminal determines, based on a second preset rule, a non-preferred resource used for the resource exclusion.

In this embodiment of this application, the second terminal may report the non-preferred resource to the first terminal by using auxiliary information.

In some embodiments, the second preset rule includes any one of the following:
Rule 11: when N is greater than 1, determining, based on a distance between the second terminal and the first terminal or an energy measurement value of the second terminal, the non-preferred resource set used for the resource exclusion;
Rule 12: when N is greater than 1, determining, first from non-preferred resources received by a target terminal, a non-preferred resource that can be used for the resource exclusion, and then determining, from non-preferred resources received by a non-target terminal, a non-preferred resource that can be used for the resource exclusion, where the target terminal is a receive terminal that is in the N second terminals and that performs sidelink transmission with the first terminal;
Rule 13: when N is greater than 1, determining, only from non-preferred resources received by a target terminal, a non-preferred resource that can be used for the resource exclusion, where the target terminal is a receive terminal that is in the N second terminals and that performs sidelink transmission with the first terminal; or
Rule 14: determining the non-preferred resource set based on the resource type when there are at least two resource types of non-preferred resources.

In this embodiment of this application, the energy measurement value of the second terminal may be understood as a result of measurement performed by the first terminal on received signal strength of the second terminal.

In some embodiments, with respect to Rule 11, it may be understood that when non-preferred resources that can be used are from a plurality of second terminals, the first terminal determines, based on the distance between the second terminal and the first terminal or the energy measurement value of the second terminal, which non-preferred resource corresponding to the second terminal is used.

In some embodiments, with respect to Rule 12, it may be understood that when non-preferred resources that can be used are from a plurality of second terminals, the first terminal preferentially uses a non-preferred resource sent by a receive terminal of the first terminal.

In some embodiments, with respect to Rule 13, it may be understood that when non-preferred resources that can be used are from a plurality of second terminals, the first terminal only uses a non-preferred resource sent by a receive terminal of the first terminal.

In some embodiments, with respect to Rule 14, it may be understood that the resource exclusion is performed, based on the resource type, by using a corresponding non-preferred resource.

In some embodiments, it may be agreed in a protocol that different resource types have different priorities, and the corresponding non-preferred resource is selected based on a priority of a resource type.

In some embodiments, before a first terminal determines a non-preferred resource set, the method further includes:

The first terminal obtains a target list used by the second terminal, where the target list includes a source address and a target address, and the target list is used by the first terminal to determine the target terminal.

In some embodiments, a definition of the resource type may be set according to an actual requirement. For example, in some embodiments, the resource type includes at least one of the following:
a first type, where a non-preferred resource corresponding to the first type is a non-preferred resource determined by the second terminal based on a first reserved resource of another terminal, and an RSRP measurement value associated with the first reserved resource is greater than or equal to a third preset value;
a second type, where a non-preferred resource corresponding to the second type is a non-preferred resource determined by the second terminal based on a second reserved resource of another terminal, and an RSRP measurement value associated with the second reserved resource is less than or equal to a fourth preset value;
a third type, where a non-preferred resource corresponding to the third type is a non-preferred resource determined by the second terminal based on an unexpected sidelink receive resource;
a fourth type, where a non-preferred resource corresponding to the fourth type is a sidelink transmission resource of the second terminal; or
a fifth type, where a non-preferred resource corresponding to the fifth type is a time domain resource that conflicts with a target channel of the second terminal when the first terminal sends a physical sidelink shared channel (PSSCH) to the second terminal.

In some embodiments, the fifth type includes at least one of the following:
a first sub-type, where a target channel corresponding to the first sub-type includes a physical sidelink feedback channel (PSFCH);
a second sub-type, where a target channel corresponding to the second sub-type includes the PSSCH;
a third sub-type, where a target channel corresponding to the third sub-type includes a receive PSSCH and an uplink transmit channel;
a fourth sub-type, where a target channel corresponding to the fourth sub-type includes a transmit PSFCH and an uplink transmit channel; or
a fifth sub-type, where a target channel corresponding to the fifth sub-type includes at least two transmit PSFCHs.

In this embodiment of this application, the non-preferred resource corresponding to the first sub-type may be understood as a time domain resource that causes a PSFCH sending and receiving conflict for the second terminal, that is, a half-duplex conflict, when the first terminal sends the PSSCH to the second terminal.

In some embodiments, the non-preferred resource corresponding to the second sub-type may be understood as a time resource that causes a PSSCH sending and receiving conflict for the second terminal, that is, a half-duplex conflict, when the first terminal sends the PSSCH to the second terminal, for example, a time domain resource used for SL transmission of the second terminal.

In some embodiments, the non-preferred resource corresponding to the third sub-type may be understood as a time domain resource that causes a conflict between PSSCH receiving and Uplink (UL) sending for the second terminal when the first terminal sends the PSSCH to the second terminal.

In some embodiments, the non-preferred resource corresponding to the fourth sub-type may be understood as a time domain resource that causes a conflict between PSFCH sending and UL sending for the second terminal, that is, a simultaneous sending conflict, when the first terminal sends the PSSCH to the second terminal.

In some embodiments, the non-preferred resource corresponding to the fifth sub-type may be understood as a time domain resource that causes a conflict of sending of a plurality of PSFCHs for the second terminal, that is, a simultaneous sending conflict, when the first terminal sends the PSSCH to the second terminal.

It should be noted that, in some embodiments, the first sub-type to the fifth sub-type may not be classified into a same type. To be specific, there is no concept of the fifth type, and both the first sub-type to the fifth sub-type and the first type to the fourth type are resource types of non-preferred resources. In this case, the resource types may include at least one of the following: the first type, the second type, the third type, the fourth type, a fifth type (corresponding to the first sub-type), a sixth type (corresponding to the second sub-type), a seventh type (corresponding to the third sub-type), an eighth type (corresponding to the fourth sub-type), or a ninth type (corresponding to the fifth sub-type).

In some embodiments, when the second preset rule includes the determining the non-preferred resource set based on the resource type when there are at least two resource types of non-preferred resources, the second preset rule satisfies:

The first terminal determines, based on a destination of a sent transport block, a resource type of the non-preferred resource used for the resource exclusion.

In some embodiments, the resource type of the non-preferred resource used for the resource exclusion satisfies at least one of the following:

When the first terminal sends the transport block to the second terminal, the non-preferred resource set includes the non-preferred resource corresponding to each of at least one of the first type, the second type, the third type, the fourth type, or the fifth type.

When the first terminal sends the transport block to any terminal, the non-preferred resource set includes the non-preferred resource corresponding to each of at least one of the second type or the fourth type.

In some embodiments, the second preset rule further satisfies at least one of the following:

The distance between the second terminal and the first terminal is less than or equal to a fifth preset value.

The energy measurement value of the second terminal is less than or equal to a sixth preset value.

The first terminal determines, based on a cast type of a sent transport block, a resource type of the non-preferred resource used for the resource exclusion, where the cast type of the transport block includes at least one of unicast, groupcast, or broadcast.

It should be noted that, with respect to the fifth preset value and the sixth preset value, values of the fifth preset value and the sixth preset value that may correspond to non-preferred resources of different resource types may be different, and specific values may be set according to an actual requirement.

In this embodiment of this application, non-preferred resources of different resource types may correspond to different cast types.

In some embodiments, different resource types correspond to different first identifiers, or different resource types with a same use condition correspond to a same second identifier, the second identifier indicates a use condition of a resource type, and the use condition is a condition based on which the non-preferred resource set may be determined.

In some embodiments, different auxiliary information may correspond to different identifiers, and different fields of the auxiliary information correspond to different identifiers.

In another embodiment, the second preset rule may be further set, according to an actual requirement, to include any one of the following:

when N is greater than 1, determining non-preferred resources received from M1 second terminals as the non-preferred resource set, where the M1 second terminals are second terminals that are associated with a preset non-preferred resource and that are in the N second terminals, and M1 is a positive integer less than N; or

when N is greater than 1, determining non-preferred resources received from M2 second terminals as the non-preferred resource set, where the M2 second terminals are a portion of second terminals independently determined by the first terminal, and M2 is a positive integer less than N.

To better understand this application, the following uses a portion of examples for description.

Embodiment 1: For at least when resource exclusion occurs after step 2.6 (not excluding another case), resource selection enhancement solutions are as follows.

Solution 1: A quantity or a proportion of non-preferred resources that can be used for the resource exclusion by UE is limited.

A limit value is agreed upon in a protocol, pre-configured, or configured, to limit the quantity of the non-preferred resources that can be used for the resource exclusion, a maximum quantity, a minimum quantity, and a range of the quantity.

In some embodiments, a proportion of non-preferred resources used for the resource exclusion in an initial candidate resource set or in a resource selection window is less than/equal to y %, where y % is the limit value.

For example, y % is agreed upon in a protocol, configured, pre-configured, or obtained according to an agreed rule.

For example, when y %=1-x % or y %<1-x %, a quantity of non-preferred resources that can be excluded is less than or equal to (1-x %)*M_total, and no dead cycle occurs in step 2.4 to step 2.7.

In some embodiments, when a quantity of non-preferred resources detected by the UE is greater than the limit value, the UE selects a portion of the non-preferred resources for the resource exclusion, and a quantity of selected non-preferred resources is a quantity required by the limit value.

In some embodiments, when a quantity of non-preferred resources detected by the UE is less than or equal to the limit value, all the detected non-preferred resources are used for the resource exclusion.

In some embodiments, it is assumed that the resource exclusion is performed based on the foregoing manner. When a quantity of remaining candidate resources is greater than or equal to x %*M_total, the UE may exclude as many non-preferred resources as possible, provided that the quantity of the remaining candidate resources is greater than or equal to x %*M_total.

Solution 2: A quantity or a proportion of candidate resources that are excluded based on a non-preferred resource is limited.

In some embodiments, after a non-preferred resource is excluded, a decrease in a proportion of candidate resources in a candidate resource set is less than or equal to y %, where the proportion is a proportion of remaining candidate resources to candidate resources in an initial candidate resource set. UE may exclude as many non-preferred resources as possible, provided that the foregoing condition is satisfied.

For example, y % is agreed upon in a protocol, configured, pre-configured, or obtained according to an agreed rule.

In some embodiments, after a non-preferred resource is excluded, a decrease in a quantity of candidate resources in a candidate resource set is less than or equal to y % or Y, where y % is a ratio of candidate resources that are excluded to the candidate resources before the exclusion. UE may exclude as many non-preferred resources as possible, provided that the foregoing condition is satisfied.

For example, y % or Y is agreed upon in a protocol, configured, pre-configured, or obtained according to an agreed rule.

In some embodiments, it is assumed that the resource exclusion is performed based on the foregoing manner. When a quantity of remaining candidate resources is greater than or equal to x %*M_total, the UE may exclude as many non-preferred resources as possible, provided that the quantity of the remaining candidate resources is greater than or equal to x %*M_total.

Solution 3: A proportion of candidate resources in a candidate resource set is reduced or controlled, for example, x % in step 2.7 is reduced.

In some embodiments, when UE performs resource exclusion based on a non-preferred resource, the UE determines, by using an additionally configured or pre-configured proportion y %, whether determining of the candidate resource set is completed. In some embodiments, y %<x %, where x % is a proportion used when the resource exclusion is performed by using a conventional technology (for example, step 2.7).

In some embodiments, when UE performs resource exclusion based on a non-preferred resource, the UE assumes that the proportion x % has an offset, and determines, based on a proportion (x %−offset), whether determining of the candidate resource set is completed.

In some embodiments, the offset is agreed upon in a protocol, configured, pre-configured, or obtained according to an agreed rule.

In some embodiments, the offset is determined based on a quantity of non-preferred resources. For example, the offset is a proportion of non-preferred resources to the candidate resources in the initial candidate resource set.

Solution 4: A base of a proportion of candidate resources in a candidate resource set is reduced or controlled, for example, M_total in step 2.7 is reduced.

In some embodiments, when UE performs resource exclusion based on a non-preferred resource, the UE assumes that the base of the proportion is M_total−offset/M_total*y %, and determines, based on M_total−offset/M_total*y %, whether determining of the candidate resource set is completed.

In some embodiments, the offset or y % is agreed upon in a protocol, configured, pre-configured, or obtained according to an agreed rule. For example, a value of the offset is a quantity of non-preferred resources that used by the UE for the resource exclusion.

In some embodiments, the offset or y % is determined based on a quantity of non-preferred resources. For example, the offset is the quantity of the non-preferred resources.

Solution 5: An upper limit value of an RSRP threshold is set.

When UE performs resource exclusion based on a non-preferred resource, an upper limit value of the RSRP threshold used for the resource exclusion is agreed upon in a protocol, pre-configured, or configured.

In some embodiments, when a terminal does not need to perform the resource exclusion based on the non-preferred resource, the RSRP threshold used for the resource exclusion does not have the upper limit value.

Solution 6: When a quantity of non-preferred resources is greater than a preset value (for example, (1-x %)*M_total), UE does not exclude a non-preferred resource, or UE retrieves a portion of resources from non-preferred resources that have been excluded, so that a quantity of remaining resources is greater than/not less than x %*M_total. Therefore, a dead cycle is at least prevented from step 2.4 to step 2.7.

Solution 7: When a quantity of non-preferred resources or a quantity of resources that are excluded based on a non-monitored slot is greater than a preset value (for example, (1-x %)*M_total), UE performs the following behavior:

The UE does not exclude a non-preferred resource and/or restores a resource that is excluded based on the non-monitored slot.

In some embodiments, the UE retrieves a portion of resources from non-preferred resources that have been excluded and/or resources that are excluded based on the non-monitored slot, so that a quantity of remaining resources is greater than/not less than x %*M_total.

In this embodiment of this application, the dead cycle is at least avoided to occur in step 2.4 to step 2.7. It should be noted that in this embodiment of this application, less than may be replaced with less than or equal to, or may be replaced with not greater than; and greater than may be replaced with greater than or equal to, or may be replaced with not less than.

Embodiment 2: For at least when resource exclusion occurs after step 2.7 (not excluding another case), resource selection enhancement solutions are as follows.

Solution 1: Solution 1 is the same as Solution 1 in Embodiment 1.

Solution 8: Solution 2 in Embodiment 1 may be included, and the following solution may be further included: After a non-preferred resource is excluded, a proportion of candidate resources in a candidate resource set is greater than y %, where the proportion is a proportion of remaining candidate resources to candidate resources in an initial candidate resource set. UE may exclude as many non-preferred resources as possible, provided that the foregoing condition is satisfied. In some embodiments, y % is agreed upon in a protocol, configured, pre-configured, or obtained according to an agreed rule. In some embodiments, y %<x %.

Solution 9: A quantity of remaining candidate resources in a candidate resource set is expanded, and then resource exclusion is performed based on a non-preferred resource, that is, x % in step 2.7 is increased. It is assumed that increased x % is denoted as y %.

When UE performs the resource exclusion based on the non-preferred resource, x % in step 2.7 is replaced with y %. When the UE performs existing resource exclusion (the resource exclusion is not performed based on the non-preferred resource set), x % in step 2.7 is unchanged.

In some embodiments, when the UE performs the resource exclusion based on the non-preferred resource, after a non-preferred resource is excluded, a proportion of candidate resources in the candidate resource set is greater than or equal to x %, where the proportion is a proportion of remaining candidate resources to candidate resources in an initial candidate resource set. The UE may exclude as many non-preferred resources as possible, provided that the proportion of the candidate resources in the candidate resource set is greater than or equal to x %.

Solution 10: When UE performs resource exclusion based on a non-preferred resource, and a quantity of reported resources is less than x %*M_total, the UE triggers resource reselection or the UE readjusts a resource selection window to perform resource reselection.

Solution 11: When resource exclusion based on a non-preferred resource is performed by a MAC layer, a physical layer reports a candidate resource set and the non-preferred resource to the MAC layer.

Solution 12: When UE performs resource exclusion based on a non-preferred resource, a limit on a start time T1 and/or an end time T2 of a resource selection window is relaxed, so that the UE more flexibly adjusts the resource selection window, to control a quantity of non-preferred resources in the window.

For example, maximum duration from a start location of resource selection to T1 is greater than a preset value (the preset value is greater than a preset value in a conventional technology), or maximum duration from a start location of resource selection to T1 is not limited.

For example, a duration interval between T1 and T2 is less than a second preset value (the preset value is less than a preset value in a conventional technology).

It should be noted that in this embodiment of this application, less than may be replaced with less than or equal to, or may be replaced with not greater than; and greater than may be replaced with greater than or equal to, or may be replaced with not less than.

In embodiments of this application, a definition of each rule in the first preset rule according to which the resource exclusion is performed based on the non-preferred resource is clarified, so that it can be avoided that a quantity of candidate resources in a determined candidate resource set is less than x %*M_total and a quantity of resources that can be selected by the UE is reduced because the resource exclusion is performed after step 2.7, which cause a problem that resources are insufficient or a probability of resource collision increases, thereby affecting transmission reliability and system efficiency. In addition, it can be avoided that when the resource exclusion is performed after step 2.6, an excessive quantity of non-preferred resources are excluded, and a quantity of remaining candidate resources in the candidate resource set is always less than x %*M_total, which causes a dead cycle to occur in step 2.4 to step 2.7. In addition, a problem of high interference intensity of remaining resources in the candidate resource set due to the fact that the excessive quantity of non-preferred resources are excluded may be avoided, which affects transmission reliability. Moreover, problems of a dead cycle occurring in step 2.4 to step 2.7 and high interference intensity of remaining resources may be avoided when the resource exclusion is performed after step 2.4.

It should be noted that, the sidelink resource selection processing method provided in the embodiments of this application may be performed by a sidelink resource selection processing apparatus, or a control module that is in a sidelink resource selection processing apparatus and that is used to perform the sidelink resource selection processing method. In an embodiment of this application, the sidelink resource selection processing apparatus provided in the embodiments of this application is described by using an example in which the sidelink resource selection processing apparatus performs the sidelink resource selection processing method.

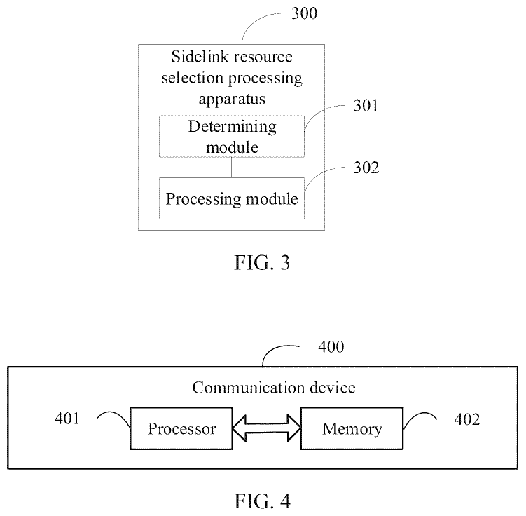

FIG. 3 is a diagram of a structure of a sidelink resource selection processing apparatus according to an embodiment of this application. As shown in FIG. 3, a sidelink resource selection processing apparatus 300 includes:

a determining module 301, configured to determine a non-preferred resource set; and

a processing module 302, configured to perform a resource exclusion behavior based on a first preset rule and the non-preferred resource set.

In some embodiments, the first preset rule includes any one of the following:
performing resource exclusion based on a first threshold for a non-preferred resource that can be used for resource exclusion by the first terminal, where the first threshold is a quantity threshold or a ratio threshold;
performing exclusion on at least a portion of non-preferred resources in the non-preferred resource set based on a second threshold;
when resource exclusion is performed based on the non-preferred resource set, determining a resource quantity requirement of a target candidate resource set based on a third threshold;
when resource exclusion is performed based on the non-preferred resource set, an upper limit value of a reference signal received power RSRP threshold is a preset value;
when a quantity of non-preferred resources used for resource exclusion is greater than a first preset value, performing a preset resource exclusion behavior;
when a sum of a quantity of non-preferred resources used for resource exclusion and a quantity of first resources is greater than a first preset value, performing a preset resource exclusion behavior, where the first resource is a resource that is excluded based on a non-monitored slot;
performing resource exclusion on an intermediate candidate resource set based on the non-preferred resource set, where the intermediate candidate resource set is a candidate resource set obtained before the resource exclusion is performed based on the non-preferred resource set, and a threshold for a resource quantity requirement of the intermediate candidate resource set is greater than a fourth threshold;
when resource exclusion is performed based on the non-preferred resource set, triggering resource reselection when a quantity of remaining resources in a candidate resource set is less than or equal to a fourth threshold;
when resource exclusion is performed by a MAC layer based on the non-preferred resource set, reporting, by a physical layer, an intermediate candidate resource set and the non-preferred resource set to the MAC layer, where the intermediate candidate resource set is a candidate resource set obtained before the resource exclusion is performed based on the non-preferred resource set; or
when resource exclusion is performed based on the non-preferred resource set, a resource selection window satisfies at least one of the following: a latest start time of the resource selection window is later than a first time; or minimum duration of the resource selection window is less than first duration, where the first time is a latest start time of a resource selection window used when the resource exclusion is not performed based on the non-preferred resource set, and the first duration is minimum duration of a resource selection window used when the resource exclusion is not performed based on the non-preferred resource set.

In some embodiments, the fourth threshold is a threshold used to determine the resource quantity requirement of the target candidate resource set when the resource exclusion is not performed based on the non-preferred resource set.

In some embodiments, when the first preset rule includes the performing resource exclusion based on a first threshold for a non-preferred resource that can be used for resource exclusion by the first terminal, the first preset rule satisfies at least one of the following:

A first quantity of non-preferred resources that can be used for the resource exclusion or a ratio of the first quantity to an initial candidate resource set is less than or equal to the first threshold.

When a first quantity of resources in the non-preferred resource set is greater than the first threshold, a terminal selects a portion of non-preferred resources for the resource exclusion, where a quantity of the portion of the non-preferred resources is less than or equal to the first threshold.

When a first quantity of resources in the non-preferred resource set is less than or equal to the first threshold, a terminal determines that all the resources in the non-preferred resource set are used for the resource exclusion.

In a process of performing the resource exclusion based on the non-preferred resource set, when the quantity of the remaining resources in the candidate resource set is less than the fourth threshold, a first quantity of non-preferred resources that can be used for the resource exclusion or a ratio of the first quantity to an initial candidate resource set is less than or equal to the first threshold; or when the quantity of the remaining resources in the candidate resource set is greater than or equal to the fourth threshold, resources in the non-preferred resource set are sequentially excluded until a first preset condition is satisfied, where the first preset condition indicates that the resources in the non-preferred resource set are continued to be excluded, so that the quantity of the remaining resources in the candidate resource set is less than the fourth threshold.

In some embodiments, when the first preset rule includes the performing exclusion on at least a portion of non-preferred resources in the non-preferred resource set based on a second threshold, the first preset rule satisfies at least one of the following:

After the resource exclusion is performed based on the non-preferred resource set, a quantity of reduced resources in the candidate resource set satisfies a second preset condition.

In a process of performing the resource exclusion based on the non-preferred resource set, when the quantity of the remaining resources in the candidate resource set is less than the fourth threshold, a quantity of reduced resources in the candidate resource set satisfies a second preset condition; or when the quantity of the remaining resources in the candidate resource set is greater than or equal to the fourth threshold, resources in the non-preferred resource set are sequentially excluded until a first preset condition is satisfied, where the first preset condition indicates that the resources in the non-preferred resource set are continued to be excluded, so that the quantity of the remaining resources in the candidate resource set is less than the fourth threshold.

In some embodiments, the second preset condition includes at least one of the following:

The quantity of the reduced resources is less than or equal to a second preset value, where the second preset value is determined based on the second threshold.

A ratio of the quantity of the reduced resources to a quantity of resources in an initial candidate resource set is less than or equal to a first preset proportion, where the first preset proportion is determined based on the second threshold.

A ratio of the quantity of the reduced resources to a quantity of resources in an initial candidate resource set is less than or equal to a second preset proportion, where the second preset proportion is determined based on the second threshold.

In some embodiments, the third threshold is a minimum ratio of a quantity of resources in the target candidate resource set to a quantity of resources in an initial candidate resource set.

In some embodiments, the third threshold is a third preset proportion that is agreed upon in a protocol, pre-configured, configured, or determined according to an agreed rule, or the third threshold is determined based on the fourth threshold and a first preset offset value.

In some embodiments, the third threshold is a ratio of a quantity of resources in the target candidate resource set to a second quantity, and the second quantity is a difference between a quantity of resources in an initial candidate resource set and a second preset offset value, or the second quantity is a product of a quantity of resources in an initial candidate resource set and a third preset proportion.

In some embodiments, the preset resource exclusion behavior includes at least one of the following:

skipping performing the resource exclusion based on the non-preferred resource set; or after performing the resource exclusion based on the non-preferred resource set, retrieving at least a portion of resources from non-preferred resources that have been excluded; or

when the sum of the quantity of the non-preferred resources used for the resource exclusion and the quantity of the first resources is greater than the first preset value, restoring at least a portion of the first resources.

In some embodiments, the first preset rule includes:

when a quantity of remaining resources in a candidate resource set is greater than or equal to a fourth threshold, sequentially excluding resources in the non-preferred resource set until a first preset condition is satisfied, where the first preset condition indicates that the resources in the non-preferred resource set are continued to be excluded, so that the quantity of the remaining resources in the candidate resource set is less than the fourth threshold.

In some embodiments, the determining module 301 includes:

a receiving unit, configured to receive non-preferred resources from N second terminals, where N is a positive integer; and

a determining unit, configured to: when a quantity of received non-preferred resources is greater than a quantity of non-preferred resources that can be used for resource exclusion by a first terminal, determine, by the first terminal based on a second preset rule, a non-preferred resource used for the resource exclusion.

In some embodiments, the second preset rule includes any one of the following:
when N is greater than 1, determining, based on a distance between the second terminal and the first terminal or an energy measurement value of the second terminal, the non-preferred resource set used for the resource exclusion;
when N is greater than 1, determining, first from non-preferred resources received by a target terminal, a non-preferred resource that can be used for the resource exclusion, and then determining, from non-preferred resources received by a non-target terminal, a non-preferred resource that can be used for the resource exclusion, where the target terminal is a receive terminal that is in the N second terminals and that performs sidelink transmission with the first terminal;
when N is greater than 1, determining, only from non-preferred resources received by a target terminal, a non-preferred resource that can be used for the resource exclusion, where the target terminal is a receive terminal that is in the N second terminals and that performs sidelink transmission with the first terminal; or
determining the non-preferred resource set based on the resource type when there are at least two resource types of non-preferred resources.

In some embodiments, the sidelink resource selection processing apparatus further includes:

an obtaining module, configured to obtain a target list used by the second terminal, where the target list includes a source address and a target address, and the target list is used by the first terminal to determine the target terminal.

In some embodiments, the resource type includes at least one of the following:
a first type, where a non-preferred resource corresponding to the first type is a non-preferred resource determined by the second terminal based on a first reserved resource of another terminal, and an RSRP measurement value associated with the first reserved resource is greater than or equal to a third preset value;
a second type, where a non-preferred resource corresponding to the second type is a non-preferred resource determined by the second terminal based on a second reserved resource of another terminal, and an RSRP measurement value associated with the second reserved resource is less than or equal to a fourth preset value;
a third type, where a non-preferred resource corresponding to the third type is a non-preferred resource determined by the second terminal based on an unexpected sidelink receive resource;
a fourth type, where a non-preferred resource corresponding to the fourth type is a sidelink transmission resource of the second terminal; or
a fifth type, where a non-preferred resource corresponding to the fifth type is a time domain resource that conflicts with a target channel of the second terminal when the first terminal sends a physical sidelink shared channel PSSCH to the second terminal.

In some embodiments, the fifth type includes at least one of the following:
a first sub-type, where a target channel corresponding to the first sub-type includes a physical sidelink feedback channel PSFCH;
a second sub-type, where a target channel corresponding to the second sub-type includes the PSSCH;
a third sub-type, where a target channel corresponding to the third sub-type includes a receive PSSCH and an uplink transmit channel;
a fourth sub-type, where a target channel corresponding to the fourth sub-type includes a transmit PSFCH and an uplink transmit channel; or
a fifth sub-type, where a target channel corresponding to the fifth sub-type includes at least two transmit PSFCHs.

In some embodiments, when the second preset rule includes the determining the non-preferred resource set based on the resource type when there are at least two resource types of non-preferred resources, the second preset rule satisfies:

The first terminal determines, based on a destination of a sent transport block, a resource type of the non-preferred resource used for the resource exclusion.

In some embodiments, the resource type of the non-preferred resource used for the resource exclusion satisfies at least one of the following:

When the first terminal sends the transport block to the second terminal, the non-preferred resource set includes the non-preferred resource corresponding to each of at least one of the first type, the second type, the third type, the fourth type, or the fifth type.

When the first terminal sends the transport block to any terminal, the non-preferred resource set includes the non-preferred resource corresponding to each of at least one of the second type or the fourth type.

In some embodiments, the second preset rule further satisfies at least one of the following:

The distance between the second terminal and the first terminal is less than or equal to a fifth preset value.

The energy measurement value of the second terminal is less than or equal to a sixth preset value.

The first terminal determines, based on a cast type of a sent transport block, a resource type of the non-preferred resource used for the resource exclusion, where the cast type of the transport block includes at least one of unicast, groupcast, or broadcast.

In some embodiments, different resource types correspond to different first identifiers, or different resource types with a same use condition correspond to a same second identifier, the second identifier indicates a use condition of a resource type, and the use condition is a condition based on which the non-preferred resource set may be determined.

The sidelink resource selection processing apparatus provided in this embodiment of this application can implement processes in the method embodiment in FIG. 2. To avoid repetition, details are not described herein again.

The sidelink resource selection processing apparatus in this embodiment of this application may be an apparatus or an apparatus or electronic device with an operating system, or may be a component, an integrated circuit, or a chip in a terminal. The apparatus may be a mobile terminal, or a non-mobile terminal. For example, the mobile terminal may include but is not limited to the foregoing listed types of the terminal 11. The non-mobile terminal may be a server, a Network Attached Storage (NAS), a personal computer (PC), a television (TV), a teller machine, a self-service machine, or the like. This is not specifically limited in this embodiment of this application.

In some embodiments, as shown in FIG. 4, an embodiment of this application further provides a communication device 400, including a processor 401, a memory 402, and a program or an instruction that is stored in the memory 402 and may be run on the processor 401. When the program or the instruction is executed by the processor 401, the processes of the foregoing embodiment of the sidelink resource selection processing method can be implemented, and a same technical effect can be achieved. To avoid repetition, details are not described herein again.

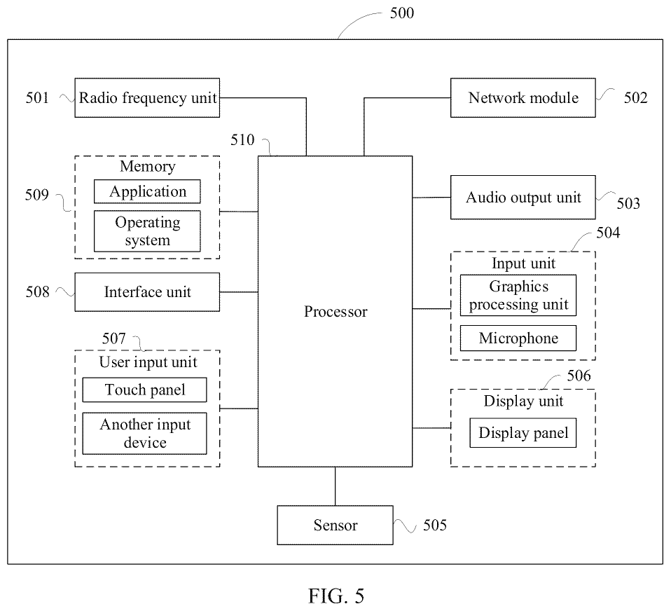

An embodiment of this application further provides a terminal, including a processor and a communication interface. The processor is configured to: determine a non-preferred resource set; and perform a resource exclusion behavior based on a first preset rule and the non-preferred resource set. The terminal embodiment corresponds to the foregoing method embodiment on the terminal side. Each implementation process and implementation of the foregoing method embodiment may be applicable to the terminal embodiment, and a same technical effect can be achieved. FIG. 5 is a schematic diagram of a hardware structure of a terminal according to an embodiment of this application.

A terminal 500 includes but is not limited to components such as a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (such as a battery) that supplies power to each component. The power supply may be logically connected to the processor 510 by using a power supply management system, to implement functions such as charging and discharging management, and power consumption management by using the power supply management system. The terminal structure shown in FIG. 5 constitutes no limitation on the terminal, and the terminal may include more or fewer components than those shown in the figure, or combine some components, or have different component arrangements. Details are not described herein.

It should be understood that in this embodiment of this application, the input unit 504 may include a Graphics Processing Unit (GPU) and a microphone. The graphics processing unit processes image data of a static picture or a video obtained by an image capture apparatus (for example, a camera) in a video capture mode or an image capture mode. The display unit 506 may include a display panel. The display panel may be configured in a form such as a liquid crystal display or an organic light-emitting diode. The user input unit 507 may include a touch panel and another input device. The touch panel is also referred to as a touchscreen. The touch panel may include two parts: a touch detection apparatus and a touch controller. The another input device may include but is not limited to a physical keyboard, a functional button (such as a volume control button or a power on/off button), a trackball, a mouse, and a joystick. Details are not described herein.

In this embodiment of this application, the radio frequency unit 501 receives downlink data from a network side device and then sends the downlink data to the processor 510 for processing; and sends uplink data to the network side device. Usually, the radio frequency unit 501 includes but is not limited to an antenna, at least one amplifier, a transceiver, a coupler, a low noise amplifier, a duplexer, and the like.

The memory 509 may be configured to store a software program or an instruction and various data. The memory 109 may mainly include a program or instruction storage area and a data storage area. The program or instruction storage area may store an operating system, an application or an instruction required by at least one function (for example, a sound playing function or an image playing function), and the like. In addition, the memory 509 may include a high-speed random access memory, and may further include a non-transitory memory. The non-transitory memory may be a Read-Only Memory (ROM), a Programmable ROM (PROM), an Erasable PROM (EPROM), an Electrically EPROM (EEPROM), or a flash memory, for example, at least one disk storage device, a flash memory device, or another non-transitory solid-state storage device.

The processor 510 may include one or more processing units. In some embodiments, an application processor and a modem processor may be integrated into the processor 510. The application processor mainly processes an operating system, a user interface, an application, an instruction, or the like. The modem processor mainly processes wireless communication, for example, a baseband processor. It may be understood that, the modem processor may not be integrated into the processor 510.

The processor 510 is configured to: determine a non-preferred resource set; and perform a resource exclusion behavior based on a first preset rule and the non-preferred resource set.

The terminal provided in this embodiment of this application can implement the processes implemented in the method embodiment in FIG. 2, and achieve a same technical effect. To avoid repetition, details are not described herein again.

An embodiment of this application further provides a readable storage medium. The readable storage medium stores a program or an instruction. When the program or the instruction is executed by a processor, the processes of the foregoing embodiment of the sidelink resource selection processing method is implemented, and a same technical effect can be achieved. To avoid repetition, details are not described herein again.

The processor is a processor in the electronic device in the foregoing embodiment. The readable storage medium includes a computer-readable storage medium, such as a computer Read-Only Memory (ROM), a Random Access Memory (RAM), a magnetic disk, an optical disc, or the like.

An embodiment of this application further provides a chip. The chip includes a processor and a communication interface. The communication interface is coupled to the processor, and the processor is configured to run a program or an instruction, to implement the processes of the foregoing embodiment of the sidelink resource selection processing method, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a program product. The program product is stored in a non-transient storage medium, and the program product is executed by at least one processor to implement the processes of the foregoing embodiment of the sidelink resource selection processing method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the implementations of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a base station, or the like) to perform the methods described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

1. A method for sidelink resource selection processing, comprising:
determining, by a first terminal, a non-preferred resource set; and
performing, by the first terminal, a resource exclusion behavior based on a first preset rule and the non-preferred resource set.

2. The method according to claim 1, wherein the first preset rule comprises any one of the following:
performing resource exclusion based on a first threshold for a non-preferred resource that can be used for resource exclusion by the first terminal, wherein the first threshold is a quantity threshold or a ratio threshold;
performing exclusion on at least a portion of non-preferred resources in the non-preferred resource set based on a second threshold;
when resource exclusion is performed based on the non-preferred resource set, determining a resource quantity requirement of a target candidate resource set based on a third threshold;
when resource exclusion is performed based on the non-preferred resource set, an upper limit value of a reference signal received power (RSRP) threshold is a preset value;
when a quantity of non-preferred resources used for resource exclusion is greater than a first preset value, performing a preset resource exclusion behavior;
when a sum of a quantity of non-preferred resources used for resource exclusion and a quantity of first resources is greater than a first preset value, performing a preset resource exclusion behavior, wherein the first resource is a resource that is excluded based on a non-monitored slot;
performing resource exclusion on an intermediate candidate resource set based on the non-preferred resource set, wherein the intermediate candidate resource set is a candidate resource set obtained before the resource exclusion is performed based on the non-preferred resource set, and a threshold for a resource quantity requirement of the intermediate candidate resource set is greater than a fourth threshold;
when resource exclusion is performed based on the non-preferred resource set, triggering resource reselection when a quantity of remaining resources in a candidate resource set is less than or equal to a fourth threshold;
when resource exclusion is performed by a MAC layer based on the non-preferred resource set, reporting, by a physical layer, an intermediate candidate resource set and the non-preferred resource set to the MAC layer, wherein the intermediate candidate resource set is a candidate resource set obtained before the resource exclusion is performed based on the non-preferred resource set; or
when resource exclusion is performed based on the non-preferred resource set, a resource selection window satisfies at least one of the following: a latest start time of the resource selection window is later than a first time; or minimum duration of the resource selection window is less than first duration, wherein the first time is a latest start time of a resource selection window used when the resource exclusion is not performed based on the non-preferred resource set, and the first duration is minimum duration of a resource selection window used when the resource exclusion is not performed based on the non-preferred resource set.

3. The method according to claim 2, wherein the fourth threshold is a threshold used to determine the resource quantity requirement of the target candidate resource set when the resource exclusion is not performed based on the non-preferred resource set.

4. The method according to claim 2, wherein when the first preset rule comprises the performing resource exclusion based on a first threshold for a non-preferred resource that can be used for resource exclusion by the first terminal, the first preset rule satisfies at least one of the following:
a first quantity of non-preferred resources that can be used for the resource exclusion or a ratio of the first quantity to an initial candidate resource set is less than or equal to the first threshold;
when a first quantity of resources in the non-preferred resource set is greater than the first threshold, selecting, by a terminal, a portion of non-preferred resources for the resource exclusion, wherein a quantity of the portion of the non-preferred resources is less than or equal to the first threshold;
when a first quantity of resources in the non-preferred resource set is less than or equal to the first threshold, determining, by a terminal, that all the resources in the non-preferred resource set are used for the resource exclusion; or
in a process of performing the resource exclusion based on the non-preferred resource set, when the quantity of the remaining resources in the candidate resource set is less than the fourth threshold, a first quantity of non-preferred resources that can be used for the resource exclusion or a ratio of the first quantity to an initial candidate resource set is less than or equal to the first threshold; or when the quantity of the remaining resources in the candidate resource set is greater than or equal to the fourth threshold, resources in the non-preferred resource set are sequentially excluded until a first preset condition is satisfied, wherein the first preset condition indicates that the resources in the non-preferred resource set are continued to be excluded, so that the quantity of the remaining resources in the candidate resource set is less than the fourth threshold.

5. The method according to claim 2, wherein when the first preset rule comprises the performing exclusion on at least a portion of non-preferred resources in the non-preferred resource set based on a second threshold, the first preset rule satisfies at least one of the following:
after the resource exclusion is performed based on the non-preferred resource set, a quantity of reduced resources in the candidate resource set satisfies a second preset condition; or
in a process of performing the resource exclusion based on the non-preferred resource set, when the quantity of the remaining resources in the candidate resource set is less than the fourth threshold, a quantity of reduced resources in the candidate resource set satisfies a second preset condition; or when the quantity of the remaining resources in the candidate resource set is greater than or equal to the fourth threshold, resources in the non-preferred resource set are sequentially excluded until a first preset condition is satisfied, wherein the first preset condition indicates that the resources in the non-preferred resource set are continued to be excluded, so that the quantity of the remaining resources in the candidate resource set is less than the fourth threshold.

6. The method according to claim 5, wherein the second preset condition comprises at least one of the following:
the quantity of the reduced resources is less than or equal to a second preset value, wherein the second preset value is determined based on the second threshold;
a ratio of the quantity of the reduced resources to a quantity of resources in an initial candidate resource set is less than or equal to a first preset proportion, wherein the first preset proportion is determined based on the second threshold; or
a ratio of the quantity of the reduced resources to a quantity of resources in an initial candidate resource set is less than or equal to a second preset proportion, wherein the second preset proportion is determined based on the second threshold.

7. The method according to claim 2, wherein the third threshold is a minimum ratio of a quantity of resources in the target candidate resource set to a quantity of resources in an initial candidate resource set.

8. The method according to claim 2, wherein the third threshold is a ratio of a quantity of resources in the target candidate resource set to a second quantity, and the second quantity is a difference between a quantity of resources in an initial candidate resource set and a second preset offset value, or the second quantity is a product of a quantity of resources in an initial candidate resource set and a third preset proportion.

9. The method according to claim 2, wherein the preset resource exclusion behavior comprises at least one of the following:
skipping performing the resource exclusion based on the non-preferred resource set; or after performing the resource exclusion based on the non-preferred resource set, retrieving at least a portion of resources from non-preferred resources that have been excluded; or
when the sum of the quantity of the non-preferred resources used for the resource exclusion and the quantity of the first resources is greater than the first preset value, restoring at least a portion of the first resources.

10. The method according to claim 1, wherein the first preset rule comprises:
when a quantity of remaining resources in a candidate resource set is greater than or equal to a fourth threshold, sequentially excluding resources in the non-preferred resource set until a first preset condition is satisfied, wherein the first preset condition indicates that the resources in the non-preferred resource set are continued to be excluded, so that the quantity of the remaining resources in the candidate resource set is less than the fourth threshold.

11. The method according to claim 1, wherein the determining, by a first terminal, a non-preferred resource set comprises:
receiving, by the first terminal, non-preferred resources from N second terminals, wherein N is a positive integer; and
when a quantity of received non-preferred resources is greater than a quantity of non-preferred resources that can be used for resource exclusion by the first terminal, determining, by the first terminal based on a second preset rule, a non-preferred resource used for the resource exclusion.

12. The method according to claim 11, wherein the second preset rule comprises any one of the following:
when N is greater than 1, determining, based on a distance between the second terminal and the first terminal or an energy measurement value of the second terminal, the non-preferred resource set used for the resource exclusion;
when N is greater than 1, determining, first from non-preferred resources received by a target terminal, a non-preferred resource that can be used for the resource exclusion, and then determining, from non-preferred resources received by a non-target terminal, a non-preferred resource that can be used for the resource exclusion, wherein the target terminal is a receive terminal that is in the N second terminals and that performs sidelink transmission with the first terminal;
when N is greater than 1, determining, only from non-preferred resources received by a target terminal, a non-preferred resource that can be used for the resource exclusion, wherein the target terminal is a receive terminal that is in the N second terminals and that performs sidelink transmission with the first terminal; or
determining the non-preferred resource set based on the resource type when there are at least two resource types of non-preferred resources.

13. The method according to claim 12, wherein before the determining, by a first terminal, a non-preferred resource set, the method further comprises:
obtaining, by the first terminal, a target list used by the second terminal, wherein the target list comprises a source address and a target address, and the target list is used by the first terminal to determine the target terminal.

14. The method according to claim 12, wherein the resource type comprises at least one of the following:
a first type, wherein a non-preferred resource corresponding to the first type is a non-preferred resource determined by the second terminal based on a first reserved resource of another terminal, and an RSRP measurement value associated with the first reserved resource is greater than or equal to a third preset value;
a second type, wherein a non-preferred resource corresponding to the second type is a non-preferred resource determined by the second terminal based on a second reserved resource of another terminal, and an RSRP measurement value associated with the second reserved resource is less than or equal to a fourth preset value;
a third type, wherein a non-preferred resource corresponding to the third type is a non-preferred resource determined by the second terminal based on an unexpected sidelink receive resource;
a fourth type, wherein a non-preferred resource corresponding to the fourth type is a sidelink transmission resource of the second terminal; or
a fifth type, wherein a non-preferred resource corresponding to the fifth type is a time domain resource that conflicts with a target channel of the second terminal when the first terminal sends a physical sidelink shared channel (PSSCH) to the second terminal.

15. The method according to claim 14, wherein the fifth type comprises at least one of the following:
a first sub-type, wherein a target channel corresponding to the first sub-type comprises a physical sidelink feedback channel (PSFCH);
a second sub-type, wherein a target channel corresponding to the second sub-type comprises the PSSCH;
a third sub-type, wherein a target channel corresponding to the third sub-type comprises a receive PSSCH and an uplink transmit channel;
a fourth sub-type, wherein a target channel corresponding to the fourth sub-type comprises a transmit PSFCH and an uplink transmit channel; or
a fifth sub-type, wherein a target channel corresponding to the fifth sub-type comprises at least two transmit PSFCHs.

16. The method according to claim 14, wherein when the second preset rule comprises the determining the non-preferred resource set based on the resource type when there are at least two resource types of non-preferred resources, the second preset rule satisfies:
determining, by the first terminal based on a destination of a sent transport block, a resource type of the non-preferred resource used for the resource exclusion,
wherein the resource type of the non-preferred resource used for the resource exclusion satisfies at least one of the following:
when the first terminal sends the transport block to the second terminal, the non-preferred resource set comprises the non-preferred resource corresponding to each of at least one of the first type, the second type, the third type, the fourth type, or the fifth type; or
when the first terminal sends the transport block to any terminal, the non-preferred resource set comprises the non-preferred resource corresponding to each of at least one of the second type or the fourth type.

17. The method according to claim 14, wherein the second preset rule further satisfies at least one of the following:
the distance between the second terminal and the first terminal is less than or equal to a fifth preset value;
the energy measurement value of the second terminal is less than or equal to a sixth preset value; or
determining, by the first terminal based on a cast type of a sent transport block, a resource type of the non-preferred resource used for the resource exclusion, wherein the cast type of the transport block comprises at least one of unicast, groupcast, and broadcast.

18. The method according to claim 11, wherein different resource types correspond to different first identifiers, or different resource types with a same use condition correspond to a same second identifier, the second identifier indicates a use condition of a resource type, and the use condition is a condition based on which the non-preferred resource set may be determined.

19. A terminal, wherein the terminal is a first terminal, comprising: a memory storing a computer program; and a processor coupled to the memory and configured to execute the computer program to perform operations comprising:
determining a non-preferred resource set; and
performing a resource exclusion behavior based on a first preset rule and the non-preferred resource set.

20. A non-transitory computer-readable storage medium, storing a computer program, when the computer program is executed by a processor, causes the processor to perform operations comprising:
determining, by a first terminal, a non-preferred resource set; and
performing, by the first terminal, a resource exclusion behavior based on a first preset rule and the non-preferred resource set.
